(19) United States
(12) Patent Application Publication
(10) Pub. No.: US 2007/0141303 A1
(43) Pub. Date: Jun. 21, 2007

(54) Sheet materials with zoned machine direction extensibility and methods of making

(76) Inventor: Eric Clayton Steindorf, Roswell, GA (US)

Correspondence Address: KIMBERLY-CLARK WORLDWIDE, INC., 401 NORTH LAKE STREET, NEENAH, WI, 54956, US

(21) Appl. No.: 11/300,753

(22) Filed: Dec. 15, 2005

(51) Int. Cl. B32B 3/10

(52) U.S. Cl. 428/136

(57) ABSTRACT

A sheet material with zoned machine direction extensibility is disclosed. The sheet material includes a plurality of discontinuous slits, wherein the plurality of discontinuous slits define at high extensibility zones extending in the machine-direction and further define low extensibility zones extending in the machine-direction. The sheet materials exhibit stable machine direction extensibility during processing and converting. Methods of making the sheet materials are also disclosed. The sheet materials are useful in a wide variety of applications not the least of which include garments, surgical drapes and other supplies as well as personal care absorbent articles including diapers, training pants, sanitary napkins, incontinence garments, bandages and the like.

### BACKGROUND OF THE INVENTION

Fibrous nonwoven webs are used in an ever-increasing number of applications. Examples of such applications include, but are not limited to, personal care products such as diapers, training pants, incontinence garments, sanitary napkins, bandages and wipers, especially where such products are limited-use and/or disposable. Other applications include health care related items such as medical or surgical drapes, gowns, masks, footwear and headwear, as well as workwear and other types of clothing. In many of these and other applications there is often a need for a fibrous nonwoven web or laminate that is extensible or elastic in nature.

There are many examples of fibrous nonwoven webs, films, and laminates that are extensible or elastic. The methods for making such materials extensible or elastic are varied. These extensible or elastic films and nonwovens may be extensible in the machine direction, the cross machine direction, or both.

A significant challenge occurs with sheet materials that are extensible in the machine direction during processing or conversion into products such as described above. When a sheet material is designed to extend in the machine direction, it is susceptible to undesired extension upon application of machine direction draw forces such as must be applied to convey the sheet material or remove the sheet material from a roll upon which it is wound. Therefore, there is a need for a method of quickly and simply producing these extensible materials so as to reduce their susceptibility to undesired extension upon application of machine direction draw forces.

### SUMMARY OF THE INVENTION

Disclosed herein is a sheet material with zoned machine direction extensibility. The sheet material includes a plurality of discontinuous slits, wherein the plurality of discontinuous slits define at least one, at least two, at least three, or at least four high extensibility zones extending in the machine-direction and further define at least one, at least two, at least three, or at least four low extensibility zones extending in the machine-direction.

Furthermore, a process for forming a sheet material including a plurality of discontinuous slits, wherein the plurality of discontinuous slits define at least two high extensibility zones extending in the machine-direction and further define at least two low extensibility zones extending in the machine-direction is described.

In one embodiment, a process for forming a sheet material with zoned machine direction extensibility includes the steps of providing a first nonwoven sheet material for forming a plurality of strips of extensible nonwoven sheet material, the first nonwoven sheet material having a machine direction; and creating a plurality of discontinuous slits in the first nonwoven sheet material, wherein the plurality of discontinuous slits defines at least two high extensibility zones extending in the machine-direction and further defines at least two low extensibility zones extending in the machine-direction. The process may further include the step of attaching an elastic substrate layer to the first nonwoven sheet material after creating the plurality of continuous slits to form an elastic laminate. The process may even further include the step of selectively bonding the low extensibility zones to further reduce the extensibility of the low extensibility zones. By selectively bonding is meant that the low extensibility zones are bonded to a greater extent than the high extensibility zones.

In another embodiment, a process for forming a sheet material with zoned machine direction extensibility includes the steps of providing a fibrous nonwoven sheet material having a machine direction and a cross machine direction and creating a plurality of discontinuous slits in the fibrous nonwoven sheet material, the slits being formed in an overlapping brick pattern, the length of the slits ranging between 3 mm and 50 mm, the distance between aligned slits in the machine-direction of the sheet material being less than 50 mm and the distance between adjacent slits in the cross direction of the sheet material being less than 50 mm, wherein the plurality of discontinuous slits define at least two high extensibility zones extending in the machine-direction and further define at least two low extensibility zones extending in the machine-direction. The process may further include the step of attaching an elastic substrate layer to the fibrous nonwoven sheet material to form an elastic laminate wherein the elastic laminate is capable of being stretched from a first length to a second and expanded length which is at least 1.25 times the first length and then upon release of the stretching forces, will retract to a third length which is no greater than 1.1 times the first length. The process may even further include the step of selectively bonding the low extensibility zones to further reduce the extensibility of the low extensibility zones.

In a further embodiment, a sheet material with zoned machine direction extensibility includes a first nonwoven sheet material for forming a plurality of strips of extensible nonwoven sheet material, the first nonwoven sheet material having a machine direction, wherein the first nonwoven sheet material includes a plurality of discontinuous slits in the first nonwoven sheet material, wherein the plurality of discontinuous slits define at least two high extensibility zones extending in the machine-direction and further define at least two low extensibility zones extending in the machine-direction. The low extensibility zones may be selectively bonded to further reduce the extensibility of the low extensibility zones.

In an even further embodiment, a sheet material with zoned machine direction extensibility includes a plurality of discontinuous slits in a fibrous nonwoven sheet material having a machine direction and a cross machine direction, the slits being formed in an overlapping brick pattern, the length of the slits ranging between 3 mm and 50 mm, the distance between aligned slits in the machine-direction of the sheet material being less than 50 mm and the distance between adjacent slits in the cross direction of the sheet material being less than 50 mm, wherein the plurality of discontinuous slits define at least two high extensibility zones extending in the machine-direction and further define at least two low extensibility zones extending in the machine-direction.

In one aspect, an elastic, fibrous nonwoven laminate includes an elastic substrate layer bonded to a sheet material with zoned machine direction extensibility as described above. The fibrous nonwoven laminate may further include a second nonwoven facing layer attached to a surface of the elastic substrate layer which is opposed to the first nonwoven facing layer. In an even further aspect, the sheet materials and elastic, fibrous nonwoven laminates described above and in further detail below may be included as a component or portion of a personal care absorbent product including, but not limited to, diapers, training pants, incontinence garments, sanitary napkins, bandages and the like.

### BRIEF DESCRIPTION OF THE DRAWINGS

FIG. 1 is a perspective view of a sheet material with zoned machine direction extensibility according to the present invention.

FIG. 2 is a top plan view of a sheet material according to the present invention in a relaxed state.

FIG. 3 is a top plan view of a sheet material according to the present invention being subjected to machine direction forces along line A-A.

FIG. 4 is a top plan view of a sheet material according to the present invention being subjected to machine direction forces along line A-A after removal of the low extension zones.

FIG. 5 is a perspective view of a slit elastic fibrous nonwoven laminate sheet material.

FIG. 6 is a perspective view of yet another slit elastic fibrous nonwoven laminate.

FIG. 7 is a schematic side view of a process for forming a sheet material with zoned machine direction extensibility according to the present invention.

FIG. 8 is a schematic side view of a process for forming a slit elastic laminate according to the present invention.

FIG. 9 is a schematic side view of another process for forming a slit elastic laminate according to the present invention.

### DEFINITIONS

Within the context of this specification, each term or phrase below will include the following meaning or meanings.

As used herein, the term “personal care product” means diapers, training pants, swimwear, absorbent underpants, adult incontinence products, and feminine hygiene products, such as feminine care pads, napkins and pantiliners.

The term “elastic” or “elasticized”, as used herein, refers to a material which, upon application of a stretching force, is extensible to an elongation of at least about 25 percent of its relaxed length, i.e., can be stretched to at least about one and one-quarter times its relaxed length, and upon release of the stretching force will recover at least about 40 percent of the elongation, i.e., will, in the case of 25% elongation, contract to an elongation of not more than about 15%. For example, a 100 centimeter length of material will, under the foregoing definition, be deemed to be elastic if it can be stretched to a length of at least about 125 centimeters and if, upon release of the stretching force, it contracts, in the case of being stretched to 125 cm, to a length of not more than about 115 centimeters. Of course, many elastic materials used in the practice of the invention can be stretched to elongations considerably in excess of 25% of their relaxed length, and many, upon release of the stretching force, will recover to their original relaxed length or very close thereto. For example, some elastic material may be elongated 60 percent, 100 percent, or more, and many of these will recover to substantially their initial relaxed length such as, for example, within 105 percent of their original relaxed length upon release of the stretching force.

As used herein, the term “nonelastic” or “inelastic” refers to any material that does not fall within the definition of “elastic” above.

As used herein, the term “extensible” or “stretchable” refers to a material that, upon application of a stretching force, is extensible to an elongation of at least about 25 percent of its relaxed length, i.e., can be stretched to at least about one and one-quarter times its relaxed length, but does not necessarily recover after removal of the stretching force.

As used herein, the terms “inextensible” or “non-extensible” refers to any material that does not fall within the definition of “extensible” above.

As used herein, the term “polymer” or “polymeric” generally includes, but is not limited to, homopolymers, copolymers, such as, for example, block, graft, random and alternating copolymers, terpolymers, etc. and blends and modifications thereof. Furthermore, the term “polymer” includes all possible geometrical configurations of the material, such as isotactic, syndiotactic and random symmetries.

The term “composite nonwoven fabric”, “composite nonwoven”, “laminate”, or “nonwoven laminate”, as used herein, unless otherwise defined, refers to a composite structure of two or more sheet material layers that have been adhered through a bonding step, such as, for example, adhesive bonding, thermal bonding, point bonding, pressure bonding, extrusion coating or ultrasonic bonding. In some embodiments, such laminates or composites may include at least one elastic material joined to at least one material. In many embodiments, such laminates or composites will have an extensible layer that is bonded to an elastic layer or material so that the laminate may be stretched between bonding locations.

As used herein, “stretch-bonded laminates” include one or more gatherable facing layers attached at spaced apart points to an elastic layer while the elastic layer is in an expanded or stretched state. Once the gatherable layers have been securely attached to the elastic layer, the elastic layer is allowed to relax, thereby causing a plurality of gathers or puckers to form in the facing layer or layers and thus creating a laminate which is elastic in at least one direction.

As used herein, the terms “gather”, “gatherable”, or “gathered” refer to a layer, laminate, individual strand, or other component that has been or can be contracted into small folds or puckers as a result of an applying force or resultant movement/displacement. Upon application of an extension force, the gathered component may be smoothed out into a non-gathered (relatively flat) relaxed state.

As used herein, the term “layer” will generally refer to a single piece of material but the same term should also be construed to mean multiple pieces or plies of material which, together, form one or more of the “layers” described herein.

As used herein, the terms “machine direction” or “MD” means the direction along the length of a fabric or sheet material corresponding to the direction along which it is produced, such as the direction along which the fabric or sheet material moves during its continuous production. The terms “cross machine direction,” “cross directional,” or “CD” mean the direction across the width of fabric or sheet material, i.e. a direction generally perpendicular to the machine direction.

As used herein, the term “nonwoven web” refers to a web having a structure of individual fibers or threads that are interlaid, but not in an identifiable, repeating manner.

Nonwoven webs have been, in the past, formed by a variety of processes such as, for example, meltblowing processes, spunbonding processes and bonded carded web processes.

As used herein, the term “fibers” encompasses both fibers of a staple length and those that are substantially continuous (e.g., filaments), and likewise includes monocomponent, multicomponent (e.g., bicomponent), monoconstituent, and multiconstituent (e.g., biconstituent) fibers, and so forth.

As used herein, the term “meltblown” or “meltblown fibers” means fibers formed by extruding a molten thermoplastic material through a plurality of fine, usually circular, die capillaries as molten thermoplastic material or filaments into a high velocity gas (e.g. air) stream which attenuates the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, which is incorporated herein in its entirety by reference thereto.

As used herein, the term “spunbond” or “spunbonded fibers” refers to small diameter fibers formed by extruding a molten thermoplastic material as filaments from a plurality of fine, usually circular, capillaries of a spinneret with the diameter of the extruded filaments then being rapidly reduced as by, for example, eductive stretching or other well-known spunbonding mechanisms. The production of spunbonded nonwoven webs is illustrated in patents such as Appel, et al., U.S. Pat. No. 4,340,563; Dorschner et al., U.S. Pat. No. 3,692,618; Kinney, U.S. Pat. Nos. 3,338,992 and 3,341,394; Levy, U.S. Pat. No. 3,276,944; Peterson, U.S. Pat. No. 3,502,538; Hartman, U.S. Pat. No. 3,502,763 and Dobo et al., U.S. Pat. No. 3,542,615. The disclosures of these patents are incorporated herein in their entireties by reference thereto.

As used herein, the term “bonded carded webs” refers to webs that are made from staple fibers, which are usually purchased in bales. The bales are placed in a fiberizing unit or picker that separates the fibers. Next, the fibers are sent through a combining or carding unit which further breaks apart and aligns the staple fibers in the machine direction so as to form a machine direction-oriented fibrous nonwoven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calendar rolls or ultrasonic bonding equipment is used to bond the fibers together, usually in a localized bond pattern through the web. Alternatively the web may be bonded across its entire surface. When using bicomponent staple fibers, through-air bonding equipment is, for many applications, especially advantageous.

As used herein, the term “coform” means a process in which at least one meltblown die is arranged near a chute through which other materials are added to the web while it is forming. Such other materials may be pulp, superabsorbent particles, cellulose or staple fibers, for example. Coform processes are shown in U.S. Pat. No. 4,818,464 to Lau and U.S. Pat. No. 4,100,324 to Anderson et al., each incorporated by reference herein in its entirety.

As used herein, the term “conjugate fibers” or “conjugate filaments” refers to fibers or filaments that have been formed from at least two polymer sources extruded from separate extruders but spun together to form one fiber or filament. Conjugate fibers or filaments are also sometimes referred to as multicomponent or bicomponent fibers or filaments. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side-by-side arrangement, a pie arrangement or an “islands-in-the-sea” arrangement. Conjugate fibers or filaments are taught, for example, in U.S. Pat. No. 5,108,820 to Kaneko et al., U.S. Pat. No. 5,336,552 to Strack et al., and U.S. Pat. No. 5,382,400 to Pike et al. For two component fibers or filaments, the polymers may be present in ratios of 75/25, 50/50, 25/75 or any other desired ratios. Polymers useful in forming conjugate fibers include those normally used in other fiber or filament forming processes.

The term “continuous filaments”, as used herein, refers to strands of continuously formed polymeric filaments. Such filaments will typically be formed by extruding molten material through a die head having a certain type and arrangement of capillary holes therein.

As used herein, the terms “sheet” and “sheet material” shall be interchangeable and in the absence of a word modifier, refer to woven materials, nonwoven webs, polymeric films, polymeric scrim-like materials, and polymeric foam sheeting.

The basis weight of nonwoven fabrics or films is usually expressed in ounces of material per square yard (osy) or grams per square meter (g/m² or gsm). Note that to convert from “osy” to “gsm”, multiply “osy” by 33.91. Fiber diameters are usually expressed in microns or denier. Film thicknesses may be expressed in microns or mil.

As used herein the term “thermal point bonding” involves passing a fabric or web of fibers to be bonded between a heated calendar roll and an anvil roll. The calendar roll is usually, though not always, patterned in some way so that the entire fabric is not bonded across its entire surface, and the anvil roll is usually flat. As a result, various patterns for calendar rolls have been developed for functional as well as aesthetic reasons. One example of a pattern has points and is the Hansen Pennings or “H&P” pattern with about a 30 percent bond area with about 200 bonds/square inch as taught in U.S. Pat. No. 3,855,046 to Hansen and Pennings, incorporated herein by reference in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent. Yet another common pattern is the C-Star pattern, which has a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen pattern having a bond area in the range of from about 15 percent to about 21 percent and about 302 bonds per square inch.

Typically, the percent bonding area varies from around 10 percent to around 30 percent of the area of the fabric laminate. As is well known in the art, the spot bonding holds the laminate layers together as well as imparts integrity to each individual layer by bonding filaments and/or fibers within each layer.

As used herein, the term “adhesive bonding” means a bonding process that forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

As used herein, the term “ultrasonic bonding” means a process performed, for example, by passing the fabric between a sonic horn and anvil roll as illustrated in U.S. Pat. No. 4,374,888 to Bornslaeger, incorporated by reference herein in its entirety.

As used herein, and in the claims, the term “comprising” is inclusive or open-ended and does not exclude additional unrecited elements, compositional components, or method steps. Accordingly, such term is intended to be synonymous with the words “has”, “have”, “having”, “includes”, “including”, and any derivatives of these words.

Unless otherwise indicated, percentages of components in formulations are by weight.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention, which broader aspects are embodied in the exemplary constructions.

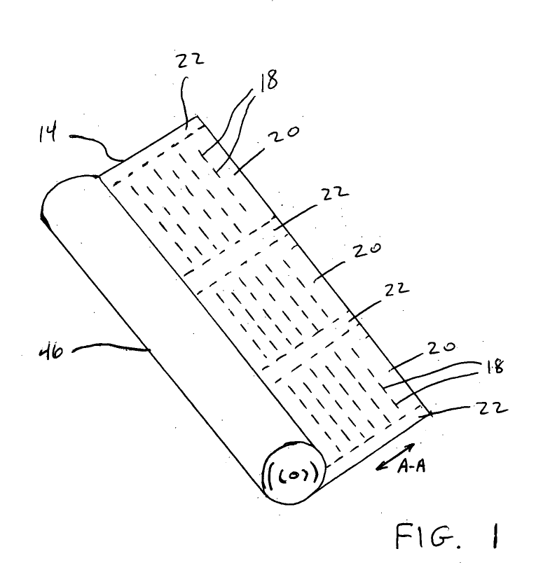

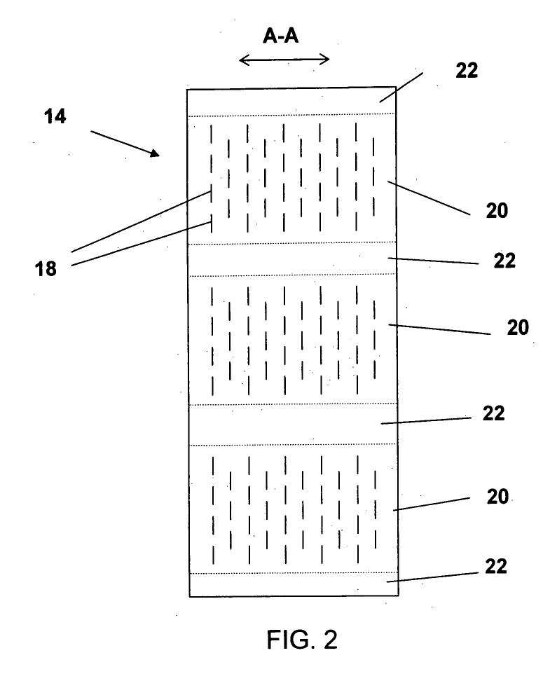

Referring to FIGS. 1 and 2, there is shown a sheet material 14 that is partially extensible in the machine direction A-A. The sheet material 14 may be wound on a roll 46. The sheet material 14 includes a plurality of discontinuous slits 18, wherein the plurality of discontinuous slits define at least one, two, three, or more high machine-direction extensibility zones 20 and further define at least one, two, three, four or more low machine-direction extensibility zones 22. The slits 18 are shown as substantially straight or linear, but such is not required, and having a long axis in the cross machine direction. The high extensibility zones 20 extend in the machine direction A-A of the sheet material 14 and include the plurality of discontinuous slits 18. Desirable slit patterns, including slit patterns having slits arranged in more than one direction, are described in U.S. Pat. No. 5,804,021 to Abuto et al., the contents of which are incorporated herein by reference. The low extensibility zones 22 also extend parallel and adjacent the high extensibility zones 20 in the machine direction A-A. The low extensibility zones 22 desirably do not include any slits 18.

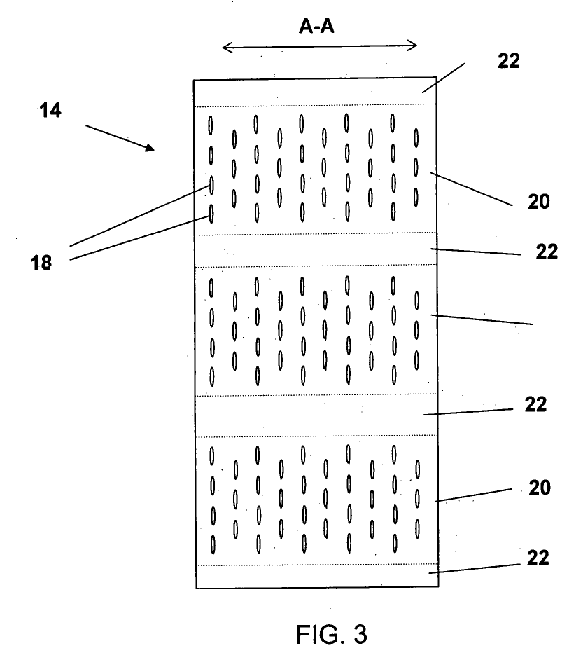

Referring to FIG. 3, the sheet material 14 is depicted while being subjected to tension in the machine direction A-A. While some slight extension of the sheet material 14 occurs, indicated by slight expansion of the slits 18, the low extension zones 22, which do not include any slits 18, bear the largest share of the applied load and prevent substantial extension from occurring.

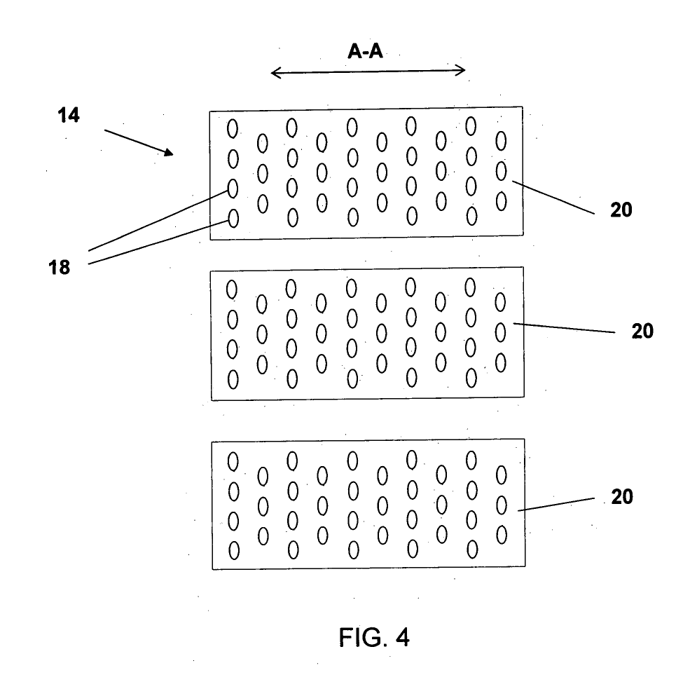

Referring to FIG. 4, the sheet material 14 is shown after removal of the low extension zones 22. FIG. 4 depicts the reaction of the remaining sheet material 14 to application of similar machine direction tension forces as in FIG. 3. As can be seen, with the low extension zones 22 having been removed, the high extension zones 20 extend fully. Thus, it is possible to obtain a highly extensible material that was not previously extended during the manufacturing or converting process.

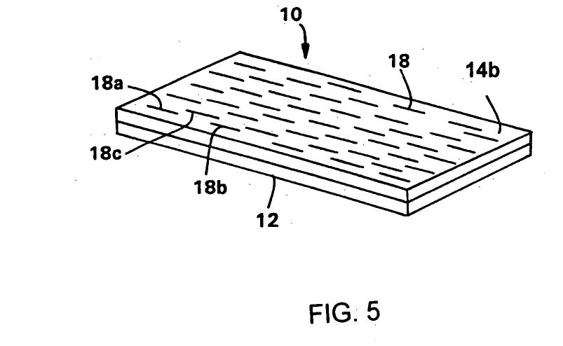

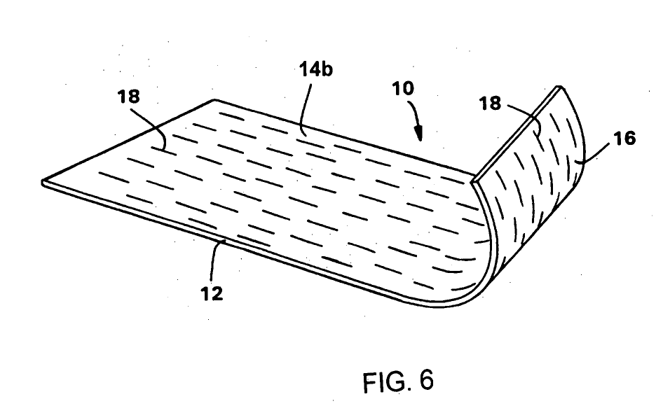

Referring to FIG. 5, there is shown an elastic, fibrous nonwoven laminate 10 including an elastic substrate layer 12 and at least a facing layer 14b. If desired, additional layers may be attached to the laminate 10 as, for example, a second fibrous nonwoven facing layer 16 on a surface of the elastic substrate layer that is opposed to the first facing layer 14b, such as shown in FIG. 6. The first and second fibrous nonwoven facing layers 14b, 16 may include a plurality of slits or openings 18 that provide extensibility to the nonwoven facing layers in a direction perpendicular to the length of the slits. Desirably, the sheet materials 14 described above including the zones of high and low extensibility 20, 22 may be used as facing layers 14b, 16 in the laminate 10. Inclusion of the zones of low extensibility 22 permits the laminate 10 to be processed without undesirable extension of the laminate occurring. Prior to inclusion in a product, the zones of low extensibility 22 may be trimmed, thus allowing full extension of the laminate 10.

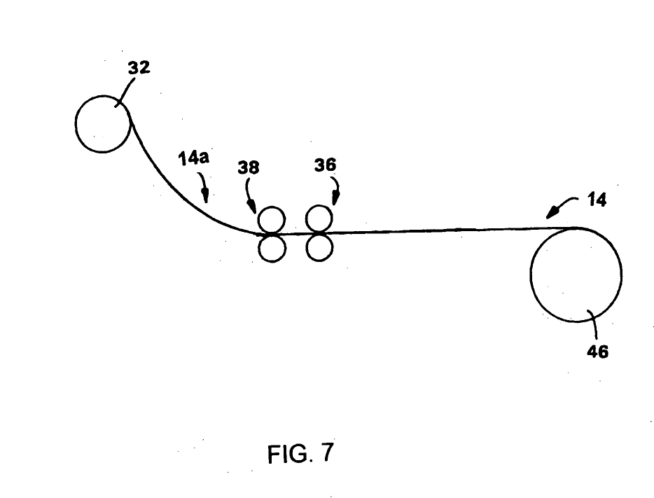

Having described the sheet material 14 that is partially extensible in the machine direction and various components of a laminate 10 including the partially extensible sheet material, a process for forming such a sheet material 14 is shown in FIG. 7. A supply of a precursor sheet material 14a is unrolled from a supply roll 32 or it also may be formed in-line. A plurality of discontinuous slits 18, such as shown in FIGS. 1-6, is formed in the precursor sheet material 14a by a slitting roll or other means 38. The slits 18 are provided in one, two, three, or more high extensibility zones 20 that extend in the machine-direction of the partially extensible sheet material 14 as described above. One, two, three, four or more low extensibility zones 22 that do not include any slits extend parallel to and adjacent the high extensibility zones 20 in the machine-direction. Thus, the low extensibility zones 22 are situated between the high extensibility zones 20. A particularly advantageous slit pattern is one wherein the slits are formed in what is generally referred to as an “overlapping brick pattern.” In this pattern the slits in one row overlap the gaps between the slits in an adjacent row. This pattern provides good expansion of the sheet material 14 in the high extension zones 20. As mentioned above, other desirable slit patterns, including patterns having slits arranged in more than one direction, are described in U.S. Pat. No. 5,804,021 to Abuto, et al. Once the high and low extensibility zones 20, 22 have been formed, the resultant sheet material 14 may be wound up on a take-up roll 46 or the sheet material may remain in-line for further processing.

Alternatively or additionally, the process may further include a means of reducing the extensibility of the low extensibility zones. As one example, the means of reducing the extensibility of the low extensibility zones may include providing additional bonding in the low extensibility zones to reduce the extensibility of the low extensibility zones 22. For a fibrous substrate, additional bonding will reduce the extensibility in the bonded areas. For example, the additional bonding may include thermal bonding, ultrasonic bonding, adhesive bonding, and so forth. As a further example, the means of reducing the extensibility of the low extensibility zones may include providing additional basis weight in the low extensibility zones. Higher basis weight in the low extensibility zone will generally result in less extensibility at a particular applied tensile force. As one example, the additional basis weight could be included during the initial production of the precursor sheet material 14a or the elastic layer 12 of a laminate 10. As another example, the additional basis weight could occur by introduction of an additional component such as a ribbon of material or one or more continuous filaments or strands. As a further example, the additional basis weigh could occur by z-folding one or more of the precursor sheet material 14a, the partially extensible sheet material 14, the elastic layer 12, or the laminate 10 in the area of the low extensibility zone.

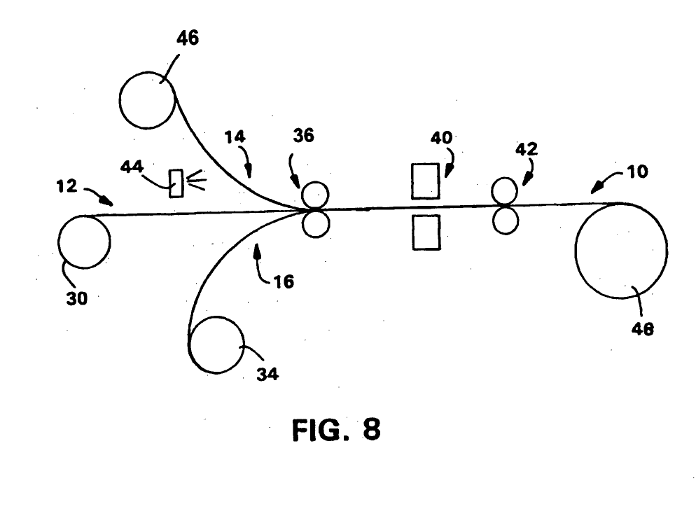

In a further embodiment, a process for forming a laminate 10 is shown in FIG. 8. A layer of elastic substrate layer 12 is unrolled from a supply roll 30 and fed through a pair of drive and compaction rolls 36. Alternatively, the elastic substrate layer 12 may be formed directly in-line. Next, a supply of a partially extensible sheet material 14 as described above having zones of high and low extensibility 20, 22 is unrolled from a supply roll 46 or it also may be formed in-line as described above. The two layers 12 and 14 are brought together, and subsequently attached to one another. Attachment can be by any suitable means such as heat bonding, ultrasonic bonding, adhesive bonding, powdered adhesive bonding, infrared bonding, radio frequency bonding, hydroentangling, mechanical entangling such as needling, and direct forming of one layer onto another, or other suitable means. The degree of attachment should be sufficient to maintain attachment during subsequent use of the laminate but not to such a degree as to prevent the slits 18 from opening up in the manner shown in FIG. 4. The attachment means in the process may include a heating apparatus 40 for providing hot air and a pair of compaction rolls 42. The surface of the compaction rolls may be smooth and/or patterned. In addition, they may be heated in which case the heating apparatus 40 may be deleted. If a spray adhesive is used, the delivery system 44 is desirably positioned such that the adhesive is applied to the interior surfaces of the substrate layer 12 and first facing layer 14. Once the two layers 12 and 14 have been attached to one another, the resultant laminate 10 may be wound up on a take-up roll 48 or the laminate 10 may remain in-line for further processing.

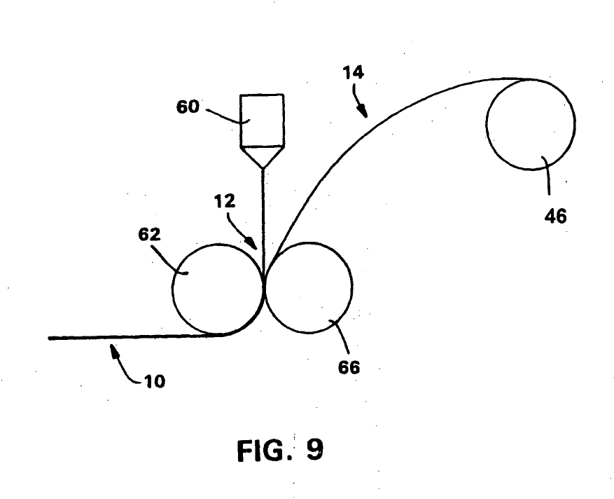

Another process for forming a laminate 10 is shown in FIG. 9 of the drawings. In this process the elastic substrate layer 12 is an extruded film emitted from a film die 60. The molten polymer is brought in contact with a chill roll 62 to help solidify the molten polymer. At the same time, a supply 46 of partially extensible sheet material 14 as described above having zones of high and low extensibility 20, 22 is brought into contact with the still tacky elastic film material 12 between the chill roll 62 and a second roll 66, such as an 85 Shore A rubber roll, which may or may not be chilled. By “chilled” it is meant that the roll 62 or 66 has a temperature that is less than the melting point of the film polymer. As a result of the elastic properties in the film layer 12, a laminate 10 is formed which will at least have elastic properties in the machine-direction. Alternatively, the film die 60 may be replaced with a continuous filament die for introduction of continuous elastic filaments in the laminate 10.

Suitable polymers for forming elastic films include both natural materials (rubber, etc.) and synthetic polymers which will yield a film with elastic properties as defined above. Thus, many of the polymers such as the KRATON® polymers and formulations mentioned above with respect to the formation of elastomeric fibers also can be used to form elastomeric films.

The processes of FIGS. 8 and 9 can be modified by adding a second fibrous nonwoven facing layer 16 to a surface of the elastic substrate layer 12 which is opposed to the first facing layer 14 to yield a laminate 10 such as is shown in FIG. 6. The same processing conditions and techniques can be used to apply the second facing layer 16 to the substrate layer 12 as were described with respect to the first facing layer 14. In addition, it has been found that to maximize the elastic properties of the resultant laminate 10, it is desirable that the slits 18 in the second facing layer 16 be in the same general direction and have the same general pattern as the slits 18 in the first facing layer 14.

The length of the slits 18 typically will range between about 3 and about 50 millimeters and the distance between aligned slits in machine direction A-A as, for example, 18a and 18b (see FIG. 1) will be less than 50 millimeters and often they will be less than 20 millimeters and in some cases less than 10 millimeters. In the cross direction, the distance between any two adjacent slits as, for example, 18b and 18c will desirably be less than 50 millimeters and generally less than 10 millimeters or even less than 5 millimeters. The basis weight of the elastic substrate layer can vary greatly depending upon the particular end use though, generally, the basis weight will be less than 250 grams per square meter and generally less than 100 grams per square meter and oftentimes even less than 50 grams per square meter.

Generally the precursor sheet material 14a will not be elastic or extensible in the machine direction in that it will not meet the requirements of the definition of an elastic or extensible material in the machine direction prior to being slit. The basis weight of the sheet material 14 will depend upon the particular end use. The process used to form the sheet material is left to the discretion of the manufacturer and the design parameters of the overall laminate 10 and/or the particular end product. Generally, it has been found that bonded carded webs and spunbond webs work particularly well as facing layers. Forming the webs from all or a portion of multiconstituent and/or multicomponent fibers such as biconstituent and bicomponent fibers can further enhance the properties of these webs. Biconstituent fibers are extruded from a homogeneous mixture of two different polymers. Such fibers combine the characteristics of the two polymers into a single fiber. Bicomponent or composite fibers are composed of two or more polymer types in distinct areas of the fiber such as in a side-by-side or sheath-core configuration.

The processes used to form the precursor sheet materials 14a include those that will result in a material that, as further described below, has the necessary range of physical properties. Suitable processes include, but are not limited to, airlaying, spunbonding and bonded carded web formation processes.

The spunbond process also can be used to form bicomponent spunbond nonwoven webs as, for example, from side-by-side polyethylene/polypropylene spunbond bicomponent fibers. The process for forming such fibers and resultant webs includes using a pair of extruders for separately supplying both the polyethylene and the polypropylene to a bicomponent spinneret. Spinnerets for producing bicomponent fibers are well known in the art and thus are not described herein in detail. In general, the spinneret includes a housing containing a spin pack which includes a plurality of plates having a pattern of openings arranged to create flow paths for directing the high melting temperature and low melting temperature polymers to each fiber-forming opening in the spinneret. The spinneret has openings arranged in one or more rows and the openings form a downwardly extending curtain of fibers when the polymers are extruded through the spinneret. As the curtain of fibers exit the spinneret, the fibers are contacted by a quenching gas that at least partially quenches the fibers and develops a latent helical crimp in the extending fibers. Oftentimes the quenching air will be directed substantially perpendicularly to the length of the fibers at a velocity of from about 30 to about 120 meters per minute at a temperature between about 70 and about 32° C.

A fiber draw unit or aspirator is positioned below the quenching gas to receive the quenched fibers. Fiber draw units or aspirators for use in meltspinning polymers are well known in the art. Exemplary fiber draw units suitable for use in the process include linear fiber aspirators of the type shown in U.S. Pat. No. 3,802,817 to Matsuki et al. and eductive guns of the type shown in the U.S. Pat. No. 3,692,618 to Dorshner et al. and U.S. Pat. No. 3,423,266 to Davies et al.

The fiber draw unit in general has an elongated passage through which the fibers are drawn by aspirating gas. The aspirating gas may be any gas, such as air that does not adversely interact with the polymers of the fibers. The aspirating gas can be heated as the aspirating gas draws the quenched fibers and heats the fibers to a temperature that is required to activate the latent crimps therein. The temperature required to activate the latent crimping within the fibers will range from about 43° C. to a maximum of less than the melting point of the low melting component polymer, which, in this case, is the polyethylene. Generally, a higher air temperature produces a higher number of crimps per unit length of the fiber.

The drawn and crimped fibers are deposited onto a continuous forming surface in a random manner, generally assisted by a vacuum device placed underneath the forming surface. The purpose of the vacuum is to eliminate the undesirable scattering of the fibers and to guide the fibers onto the forming surface to form a uniform unbonded web of bicomponent fibers. If desired, a compression roller can lightly compress the resultant web before the web is subjected to a bonding process.

One way to bond the bicomponent spunbonded web is through the use-of a through-air bonder. Such through-air bonders are well known in the art and therefore need not be described herein in detail. In the through-air bonder, a flow of heated air is applied through the web to heat the web to a temperature above the melting point of the lower melting point component of the bicomponent fibers but below the melting point of the higher melting point component. Upon heating, the lower melting polymer portions of the web fibers melt and adhere to adjacent fibers at their cross-over points while the higher melting polymer portions of the fibers tend to maintain the physical and dimensional integrity of the web.

The facing layers also may be made from bonded carded webs. Bonded carded webs are made from staple fibers, which are usually purchased in bales. The bales are placed in a picker, which separates the fibers. Next, the fibers are sent through a combing or carding unit which further breaks apart and aligns the staple fibers in the machine direction so as to form a generally machine direction-oriented fibrous nonwoven web. Once the web has been formed, it is then bonded by one or more of several bonding methods. One bonding method is powder bonding wherein a powdered adhesive is distributed through the web and then activated, usually by heating the web and adhesive with hot air. Another bonding method is pattern bonding wherein heated calendar rolls or ultrasonic bonding equipment are used to bond the fibers together, usually in a localized bond pattern though the web can be bonded across its entire surface if so desired. One of the best methods though, when using bicomponent staple fibers is to use a through-air bonder such as is described above with respect to the bicomponent spunbond web formation process.

In order to obtain the specified range of physical properties of the resultant fibrous nonwoven web, the bonding process used to bond the fibers of the fibrous nonwoven web together should be a process such as through-air bonding which can control the level of compression or collapse of the structure during the formation process. In through-air bonding, heated air is forced through the web to melt and bond together the fibers at their crossover points. Typically the unbonded web is supported on a forming wire or drum. In addition a vacuum may be pulled through the web if so desired to further contain the fibrous web during the bonding process.

Bonding processes such as point bonding and pattern bonding using smooth and/or pattern bonding rolls can be used provided such processes will create the specified range of physical properties. Whatever process is chosen, the degree of bonding will be dependent upon the fibers/polymers chosen but, in any event, it is desirable that the amount of web compression be controlled during the heating stage.

Airlaying is another well-known process by which the fibrous nonwoven webs can be made. In the airlaying process, bundles of small fibers usually having lengths ranging between about 6 and about 19 millimeters are separated and entrained in an air supply and then deposited onto a forming screen, oftentimes with the assistance of a vacuum supply. The randomly deposited fibers are then bonded to one another using, for example, hot air or a spray adhesive.

Although not required, the precursor sheet material 14a may also be necked to provide cross direction extensibility. For example, a web material may be stretched in the machine direction by passing the web through two or more pairs of driven nipped rollers, wherein an upstream pair of driven rollers is driven at a first velocity, and a downstream pair of driven rollers is driven at a second velocity that is greater than the first velocity. Because the second velocity is greater than the first velocity, the material will experience a machine direction tensioning force or biasing force as it travels through the two nips. This machine direction tensioning force will cause the material to be stretched or extended in the machine direction, and cause the material to “neck” or somewhat decrease its cross machine direction dimension or width. If the necked material is bonded or set or otherwise held in this necked conformation, it is capable of extensibility in the cross machine direction to reverse the necking. Necking may also be accomplished, and potentially to a greater extent, by drawing machine direction tension on a web over a longer span than typically used with the nip-to-nip drawing or tensioning described above. In addition, heat may be applied to the web during the necking process to aid the drawing and to help set the web in the necked conformation. Such reversibly necked materials are described in greater detail in the above-mentioned U.S. Pat. Nos. 5,336,545, 5,226,992, 4,981,747 and 4,965,122 to Morman, all incorporated herein by reference in their entireties.

The elastic substrate layer 12 may be made from any material or materials that are elastic in at least one direction and more desirably from materials that are elastic in two or more directions. Suitable elastic materials for the substrate layer 12, include, but are not limited to, elastic films, elastic nonwoven webs and elastic woven webs as well as combinations of the foregoing. Generally speaking, the elastic or elastomeric webs may be any elastomeric nonwoven fibrous web, elastomeric knitted fabric, elastomeric woven fabric or other elastic material that will exhibit elastic properties. Exemplary elastomeric knitted fabrics are knitted fabrics made utilizing elastomeric threads or yarns which provide stretch and recovery properties in at least one direction. Exemplary elastomeric woven fabrics are fabrics having elastomeric warp and/or weft threads, filaments, or yarns such as polyurethane threads that provide stretch and recovery properties in at least one direction. Desirably the elastic substrate layer may be made from an elastomeric nonwoven web such as an elastomeric nonwoven web of spunbonded filaments or an elastomeric nonwoven web of meltblown fibers.

Generally, any suitable elastomeric fiber forming resins or blends containing the same may be utilized to form the nonwoven webs of elastomeric fibers. For example, useful elastomeric fiber forming resins can include block copolymers having the general formula A-B-A′ or A-B, where A and A′ are each a thermoplastic polymer endblock which contains a styrenic moiety such as a poly (vinyl arene) and where B is an elastomeric polymer midblock such as a conjugated diene or a lower alkene polymer. Block copolymers of the A-B-A′ type can have different or the same thermoplastic block polymers for the A and A′ blocks, and these block copolymers are intended to embrace linear, branched and radial block copolymers. In this regard, the radial block copolymers may be designated (A-B)ₘ—X, wherein X is a polyfunctional atom or molecule and in which each (A-B)ₘ— radiates from X in a way such that A is an endblock. In the radial block copolymer, X may be an organic or inorganic polyfunctional atom or molecule and m is an integer having the same value as the functional group originally present in X. It is usually at least 3, and is frequently 4 or 5, but is not limited thereto. Thus, the expression “block copolymer”, and particularly “A-B-A”, “A-B”, and “A-B-A-B” block copolymer is intended to embrace all block copolymers having such rubbery blocks and thermoplastic blocks as discussed above which can be extruded (e.g., by meltblowing), and without limitation as to the number of blocks. The elastomeric nonwoven web may be formed from, for example, elastomeric (polystyrene/poly(ethylenebutylene)/polystyrene) block copolymers available from Kraton Polymers U.S., L.L.C. of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACTS 4049, 4011 and 4041 from the ExxonMobil Chemical Company of Houston, Tex., as well as blends. Still other elastomeric polymers are available, such as the elastic polyolefin resins available under the trade name VISTAMAXX from the ExxonMobil Chemical Company, Houston, Tex., and the polyolefin (propylene-ethylene copolymer) elastic resins available under the trade name VERSIFY from Dow Chemical, Midland, Mich.

Other exemplary elastomeric materials that may be used to form an elastomeric nonwoven web include polyurethane elastomeric materials such as, for example, those available under the trademark ESTANE from Noveon Inc. of Cleveland, Ohio, polyamide elastomeric materials such as, for example, those available under the trademark PEBAX from Arkema, Inc. of Philadelphia, Pa., and polyester elastomeric materials such as, for example, those available under the trade designation HYTREL® from E. I. DuPont De Nemours & Company. Formation of an elastomeric nonwoven web from polyester elastomeric materials is disclosed in, for example, U.S. Pat. No. 4,741,949 to Morman et al. Elastomeric nonwoven webs may also be formed from elastomeric copolymers of ethylene and at least one vinyl monomer such as, for example, vinyl acetates, unsaturated aliphatic monocarboxylic acids, and esters of such monocarboxylic acids. The elastomeric copolymers and formation of elastomeric nonwoven webs from those elastomeric copolymers are disclosed in, for example, U.S. Pat. No. 4,803,117.

Processing aids may be added to the elastomeric polymer. For example, a polyolefin may be blended with the elastomeric polymer (e.g., the A-B-A elastomeric block copolymer) to improve the processability of the composition. The polyolefin must be one which, when so blended and subjected to an appropriate combination of elevated pressure and elevated temperature conditions, is extrudable in blended form with the elastomeric polymer. Useful blending polyolefin materials include, for example, polyethylene, polypropylene and polybutene, including ethylene copolymers, propylene copolymers and butene copolymers. A particularly useful polyethylene may be obtained from the U.S.I. Chemical Company under the trade designation Petrothene NA 601. Two or more of the polyolefins may be utilized. Extrudable blends of elastomeric polymers and polyolefins are disclosed in, for example, U.S. Pat. No. 4,663,220 to Wisneski et al.

The elastomeric nonwoven web may also be a pressure sensitive elastomer adhesive web. For example, the elastomeric material itself may be tacky or, alternatively, a compatible tackifying resin may be added to the extrudable elastomeric compositions described above to provide an elastomeric web that can act as a pressure sensitive adhesive, e.g, to bond the elastomeric web to one of the fibrous nonwoven facing layers. In regard to the tackifying resins and tackified extrudable elastomeric compositions, note the resins and compositions as disclosed in U.S. Pat. No. 4,787,699 to Kieffer.

Any tackifier resin can be used which is compatible with the elastomeric polymer and which can withstand the high processing (e.g., extrusion) temperatures. If the elastomeric polymer (e.g., A-B-A elastomeric block copolymer) is blended with processing aids, such as for example, polyolefins or extending oils, the tackifier resin should also be compatible with those processing aids. Generally, hydrogenated hydrocarbon resins are preferred tackifying resins because of their better temperature stability. REGALREZ® and ARKON® P series tackifiers are examples of hydrogenated hydrocarbon resins. Terpene hydrocarbon tackifiers are available from Arizona Chemical Company of Wayne, N.J. under the tradename ZONATAC®. REGALREZ® hydrocarbon resins are available from Eastman Chemical Company of Kingsport, Tenn. ARKON® resins are available from Arakawa Chemical (U.S.A) Incorporated. Of course, other tackifying resins which are compatible with the other components of the composition and which can withstand the high processing temperatures can also be used.

The elastomeric fabric may also be a multilayer material in that it may include two or more individual coherent webs and/or films. Additionally, the elastomeric fabric may be a multilayer material in which one or more of the layers contain a mixture of elastomeric and non-elastomeric fibers or particulates. As an example of the latter type of elastomeric web, reference is made to U.S. Pat. No. 4,209,563 to Sisson, in which elastomeric and non-elastomeric fibers are commingled to form a single coherent web of randomly dispersed fibers. Another example of such an elastomeric composite web would be one made by a technique such as is disclosed in U.S. Pat. No. 4,741,949 to Morman et al. and U.S. Pat. No. 4,100,324 to Anderson et al. and U.S. Pat. No. 4,803,117 to Daponte.

These patents disclose nonwoven materials that include a mixture of meltblown thermoplastic fibers and other materials that form a coform material. Such mixtures may be formed by adding fibers and/or particulates to the gas stream in which elastomeric meltblown fibers are carried so that an intimate entangled commingling of the elastomeric meltblown fibers and other materials occurs prior to collection of the meltblown fibers upon a collection device to form a coherent web of randomly dispersed meltblown fibers and other materials. Useful materials that may be used in such nonwoven elastomeric composite webs include, for example, wood pulp fibers, staple length fibers from natural and synthetic sources (e.g. cotton, wool, asbestos, rayon, polyester, polyamide, glass, polyolefin, cellulose derivatives and the like), non-elastic meltblown fibers, multi-component fibers, absorbent fibers, electrically conductive fibers, and particulates such as, for example, activated charcoal/carbon, clays, starches, metal oxides, superabsorbent materials and mixtures of such materials. Other types of nonwoven elastomeric composite webs may be used. For example, a hydraulically entangled nonwoven elastomeric composite web may be used such as is disclosed in U.S. Pat. Nos. 4,879,170 and 4,939,016 both to Radwanski, et al.

If the elastomeric nonwoven web is an elastomeric nonwoven web of meltblown fibers, the meltblown fibers may range, for example, from about 0.1 to about 100 microns in diameter. However, if barrier properties are important in the finished laminate (for example, if it is important that the final laminate material have increased opacity and/or insulating and/or dirt protection and/or liquid repellency), then finer fibers which may range, for example, from about 0.5 to about 20 microns can be used.

The basis weight of the elastomeric fabric may range from about 5 to about 250 grams per square meter. The basis weight can be varied, however, to provide desired properties including recovery and barrier properties, desirably, the basis weight of the elastomeric fabric may range from about 30 to about 100 grams per square meter. Even more particularly, the basis weight of the elastomeric fabric may range from about 35 to about 70 grams per square meter. The extreme thinness of the low basis weight elastomeric nonwoven webs that may be used in certain embodiments would appear to enhance the material properties of drape and conformability.

In addition to elastic films and nonwovens, elastic wovens also may be used as the elastic layer in an elastic laminate. Woven materials are distinguishable from nonwovens given the deliberate and uniform pattern by which the fibers, yarns or filaments are intertwined. Conversely, nonwoven materials are formed from fibers that, at least initially, are laid down in a random pattern and then usually further strengthened by increased entanglement as with hydraulic needling and/or bonding of the fibers together.

Besides being elastic, the only other requirement for the substrate layer 12 is that it can be attachable to the facing layers 14 and 16. Where it is desired to have the overall laminate 10 be breathable, it is generally desirable to make the elastic substrate layer from a nonwoven or woven though it is also possible to make films breathable, as, for example, by perforating the films. The elastic substrate layer itself can be laminated layers as can be the nonwoven facing layer. The outer facing layers can be used to cover the elastic substrate and impart aesthetic or protective features such as, for example, abrasion resistance. These outer facings can also impart a stretch-to-stop feature. Stretch-to-stop can be important in protecting the composite from tensile failure due to overextension.

As described above, the sheet materials described herein can be used in a wide variety of applications not the least of which includes garments, surgical drapes and other supplies, and personal care absorbent products such as diapers, training pants, incontinence garments, sanitary napkins, bandages and the like. For example, the elastic laminate materials may be utilized to make elastic side panels or waist bands of training pants.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged either in whole or in part. Therefore, the spirit and scope of the appended claims should not be limited to the description of the preferred versions contained therein. Further, it is recognized that many embodiments may be conceived that do not achieve all of the advantages of some embodiments, yet the absence of a particular advantage shall not be construed to necessarily mean that such an embodiment is outside the scope of the present invention. Moreover, it should be noted that any given range presented herein is intended to include any and all lesser included ranges. For example, a range of from 45-90 would also include 50-90; 45-80; 46-89 and the like. Thus, the range of 95% to 99.999% also includes, for example, the ranges of 96% to 99.1%, 96.3% to 99.7%, and 99.91% to 99.999%, etc.

1. A process for forming a sheet material with zoned machine direction extensibility comprising the steps of:
providing a first nonwoven sheet material for forming a plurality of strips of extensible nonwoven sheet material, the first nonwoven sheet material having a machine direction; and
creating a plurality of discontinuous slits in the first nonwoven sheet material, wherein the plurality of discontinuous slits defines at least two high extensibility zones extending in the machine-direction and further defines at least two low extensibility zones extending in the machine-direction.

2. The process of claim 1 further comprising the step of attaching an elastic substrate layer to the first nonwoven sheet material after creating the plurality of continuous slits to form an elastic laminate.

3. The process of claim 1 further comprising the step of selectively bonding the low extensibility zones to further reduce the extensibility of the low extensibility zones.

4. A process for forming a sheet material with zoned machine direction extensibility comprising the steps of:
creating a plurality of discontinuous slits in a fibrous nonwoven sheet material having a machine direction and a cross machine direction, the slits being formed in an overlapping brick pattern, the length of the slits ranging between 3 mm and 50 mm, the distance between aligned slits in the machine-direction of the sheet material being less than 50 mm and the distance between adjacent slits in the cross direction of the sheet material being less than 50 mm, wherein the plurality of discontinuous slits defines at least two high extensibility zones extending in the machine-direction and further defines at least two low extensibility zones extending in the machine-direction.

5. The process of claim 4 further comprising the step of attaching an elastic substrate layer to the fibrous nonwoven sheet material to form an elastic laminate wherein the elastic laminate is capable of being stretched from a first length to a second and expanded length which is at least 1.25 times the first length and then upon release of the stretching forces, will retract to a third length which is no greater than 1.1 times the first length.

6. The process of claim 4 further comprising the step of selectively bonding the low extensibility zones to further reduce the extensibility of the low extensibility zones.

7. A sheet material with zoned machine direction extensibility comprising:
a first nonwoven sheet material for forming a plurality of strips of extensible nonwoven sheet material, the first nonwoven sheet material having a machine direction, wherein the first nonwoven sheet material includes a plurality of discontinuous slits in the first nonwoven sheet material, wherein the plurality of discontinuous slits defines at least two high extensibility zones extending in the machine-direction and further defines at least two low extensibility zones extending in the machine-direction.

8. An elastic, fibrous nonwoven laminate comprising an elastic substrate layer bonded to the sheet material with zoned machine direction extensibility of claim 7.

9. The sheet material with zoned machine direction extensibility of claim 7 wherein the low extensibility zones are selectively bonded to further reduce the extensibility of the low extensibility zones.

10. The fibrous nonwoven laminate of claim 8 further comprising a second nonwoven facing layer attached to a surface of the elastic substrate layer which is opposed to the first nonwoven facing layer.

11. A personal care absorbent product, at least a portion thereof comprising the elastic, fibrous nonwoven laminate according to claim 8.

12. A sheet material with zoned machine direction extensibility comprising a plurality of discontinuous slits in a fibrous nonwoven sheet material having a machine direction and a cross machine direction, the slits being formed in an overlapping brick pattern, the length of the slits ranging between 3 mm and 50 mm, the distance between aligned slits in the machine-direction of the sheet material being less than 50 mm and the distance between adjacent slits in the cross direction of the sheet material being less than 50 mm, wherein the plurality of discontinuous slits defines at least two high extensibility zones extending in the machine-direction and further defines at least two low extensibility zones extending in the machine-direction.

13. An elastic, fibrous nonwoven laminate comprising an elastic substrate layer bonded to the sheet material with zoned machine direction extensibility of claim 12.

14. The sheet material with zoned machine direction extensibility of claim 12 wherein the low extensibility zones are selectively bonded to further reduce the extensibility of the low extensibility zones.

15. The fibrous nonwoven laminate of claim 13 further comprising a second nonwoven facing layer attached to a surface of the elastic substrate layer which is opposed to the first nonwoven facing layer.

16. A personal care absorbent product, at least a portion thereof comprising the elastic, fibrous nonwoven laminate according to claim 13.
